(19) United States
(12) Patent Application Publication
(10) Pub. No.: US 2001/0044761 A1
(43) Pub. Date: Nov. 22, 2001

(54) Device and method for management of operating materials and/or supplies of an analyzer or analyzing system

(76) Inventors: Hans Berger, Graz (AT); Ulrich Kanter, Unterpremstatten (AT); Hellfried Karpf, Graz (AT); Werner Ziegler, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/854,560

(22) Filed: May 15, 2001

(30) Foreign Application Priority Data
May 16, 2000 (EP) 00890156.3

(51) Int. Cl. G06F 17/60

(52) U.S. Cl. 705/28

(57) ABSTRACT

An automation process for the management of operating materials and/or supplies of an analyzer or analyzing system, preferably for applications in medical, environmental or food technology, comprising the following steps:

(a) automatic recording of data on operating materials and/or supplies, in particular type and maximum useful life of the operating materials used, as well as types, expiry dates and quantities of the required supplies,

(b) entering the desired frequency of analysis, or automatic calculation of the estimated frequency of analysis from past frequencies of use of the analyzer or analyzing system,

(c) automatic calculation of the operating materials and/or supplies required per unit of time, based on the data obtained in steps (a) and (b),

(d) determining an optimum point in time for ordering the required operating materials and/or supplies,

(e) automated ordering of the operating materials and/or supplies via a device for remote data transmission, preferably via an internet connection.

### BACKGROUND OF THE INVENTION

The invention relates to a method for automation of the management of operating materials and/or supplies of an analyzer or analyzing system, preferably for use in medical, environmental or food technology, and an analyzer or analyzing system for implementation of this process.

### DESCRIPTION OF PRIOR ART

In environmental or food technology, and in particular, in laboratory or medical technology a large number of electrochemical or optochemical or spectroscopic measuring techniques and analyzers are in use today, which usually require considerable efforts involved in managing the respective operating materials and supplies. The term operating materials used in this context will refer to all hardware and software components required for operating an analyzer or analyzing system, which are subject to ageing and wear, and thus have to be renewed or replaced routinely. This includes hardware components, such as sensors, sensor cartridges (units or modules which may be replaced by the user and usually contain a number of individual sensors for different parameters in a measuring chamber), accessory parts such as tubes, seals, etc., as well as software components, such as operating systems, control and evaluation programs. The term supplies includes cleaning, calibrating and quality control media, as well as printing paper, ink cartridges, etc. If several analyzers are used which are supplied by different manufacturers, management of the necessary operating materials and supplies will require more time and staff than would be desirable, for example, for ordering and inventory management, making appointments for service and maintenance, or obtaining information on new product and software developments.

The above problems will mainly occur in the clinical field and in point-of-care-testing (POCT). Clinical chemistry is concerned with implementing and interpreting qualitative and quantitative determination of chemical or biochemical parameters in body fluids, such as blood, plasma, serum, urine, cerebrospinal fluid, faeces, and other fluids. POCT is concerned with intensive medicine, emergency medicine, and bed-side testing.

In critical care or POCT user-friendly, automated analyzers have been used for some time, which are capable of determining a large number of different parameters or parameter groups of a medical sample. One example would be the modular analyzer AVL-OMNI (AVL Medical Instruments AG, Schaffhausen, CH), which has a sample input and several measuring modules which can be individually selected for a specific analyzing task. Among others, modules for blood gas analysis (pH, PCO₂, PO₂), electrolyte measurement (Na⁺, K⁺, Cl⁻, Ca⁺⁺), metabolite measurement (glucose, lactate, urea, creatinine), for determination of hemoglobin and CO oximetry may be inserted into the analyzer. The device is provided with a computer, a user-friendly touch screen for menu selection, a thermo-printer for data print-outs, a bar code reader, and high-quality evaluation electronics plus memory for patient data.

Via its selection menus the device will support the user when sensor cartridges are to be replaced or new containers inserted for diverse supplies. Opening of the cover for the calibrating medium, for instance, will start a program which will show the further steps to be taken by the user on the touch-screen. After the empty container for the calibrating medium has been removed and a new, full container inserted, the device will either automatically read the new label via transponder, or the user is requested to enter the bar code data on the new container by means of the bar code reader, and to insert the container into the compartment provided for it in the analyzer, and close the cover. By the closing of the cover the program will be terminated and the data of the calibrating medium (composition, filling volume, expiry date, etc.) will be stored in the device.

Similar steps are required when new sensors or a new sensor cartridge are to be inserted, the sensor or sensor cartridge also featuring a bar code including all essential data, or a key to all data stored in the analyzer.

Some of the containers for the supply materials have level sensors, in others the level is calculated on the basis of the liquid volumes withdrawn, and indicated via touch-screen.

### SUMMARY OF THE INVENTION

It is an object of the present invention to propose a process for further automation of the management of all software and hardware components, which is based on the management system for operating materials and supplies described above, and to further develop an analyzer or analyzing system such that the desired automating steps can be performed in a time and cost saving manner. An additional object is concerned with improving information management in the fields of medicine, environmental and food technology.

According to the invention this object is achieved by the following steps:

(a) automatic recording of data on operating materials and/or supplies, in particular type and maximum useful life of the operating materials used, as well as types, expiry dates and quantities of the required supplies,

(b) entering the desired frequency of analysis, or automatic calculation of the estimated frequency of analysis from past frequencies of use of the analyzer or analyzing system,

(c) automatic calculation of the operating materials and/or supplies required per unit of time, based on the data obtained in steps (a) and (b),

(d) determining an optimum point in time for ordering the required operating materials and/or supplies,

(e) automated ordering of the operating materials and/or supplies via a device for remote data transmission, preferably via an internet connection.

The special advantage of the process proposed by the invention is that the user is relieved in his work and essential parts of the operating materials and supplies management are automated. Automatic recording of data after insertion of new sensor cartridges or other supplies may be effected by means of a bar code reader or transponder system, where a memory chip is provided on or in each sensor cartridge or each supply tank. The memory chip, for instance at the container for the calibrating medium, may also be used for storing the current filling level of the calibrating medium. Besides, it will suffice to enter the desired frequency of analysis once, i.e., analyses planned per unit of time, or the frequency of analysis may be proposed by the analyzer itself on the basis of data collected in previous periods of use, and confirmed by the user. This is followed by an automatic calculation of the operating materials and supplies required per unit of time, and the determination of an optimum ordering point, the location of the analyzer and, as a consequence, the time required for the entire transaction of ordering and delivery being taken into account.

Automatic ordering is effected via internet, for instance, where direct contact is established with the manufacturer, supplier, service department or a user center. The process is extremely time-saving and safe for the user, as it will not be necessary to fill out order forms or maintain an address file, and faulty information and orders will be avoided.

Most advantageously, the unit for remote data transmission, preferably an internet connection, may be utilized to provide an internet portal for information, especially information on products, software, service, maintenance, and use, in the fields of medical, environmental or food technology.

In a particular system configuration the above information will be updated whenever an automatic order is placed according to step (e) above.

Advantageously, the internet access of the analyzer or analyzing system together with input and output elements (keyboard, monitor, printer) of the analyzer can also be used for ordering other products in the POCT field or in the clinical context. The analyzer will thus assume a portal function, facilitating the management of supplies for other equipment or offering user access to electronic information media (newsletters, magazines, etc.).

By means of a single activation in the set-up program of the analyzer or by concluding a suitable maintenance contract, the user will receive via internet (push technology) the information and updates precisely corresponding to his needs and system configuration, respectively, thus optimizing his working conditions.

If will be of further advantage if the user is offered a help function via the automatic remote data transmission. In this way the user can communicate with the manufacturer, a user center, user groups, the supplier of operating materials, or the service department (chat room).

According to an advantageous variant of the invention, the internet connection can further be used for remote repair of hardware or software components of the analyzing system. Remote repair is preceded by analysis of potential error messages and analysis of the latest calibration and quality control cycles. Via the service department communicating via internet, service routines that are preconfigured in the analyzer may then be initiated to repair the fault. Moreover, programs may be downloaded which will permit fault repair by routinely utilizing analyzer components or making a special use of these components in the analyzer. By repeated washing of the sample passages, for example, or by reversing the direction of flow, or by changing the sequence of certain operational steps, it will be possible to remove deposits or contaminations in the sample passage which are not eliminated by routine washing or scrubbing.

Automatic ordering of operating materials and supplies either is effected fully automatically by the analyzer after a corresponding function has been activated once, or it is proposed by the analyzer and confirmed by the user.

For calculation of the operating materials and supplies required per unit of time according to step (c) it will be possible to enter the desired range (stock of supplies needed for a desired period of time) and/or desired availability (planned workload) of the analyzer.

In further development of the process according to the invention it is proposed that subsequent to the automated ordering of operating materials and supplies a confirmation of delivery should be waited for and, if delivery is delayed, a warning should be displayed on the analyzer. In this context it will be of advantage if the calibration and quality control cycles of the analyzer are correspondingly extended or the analyzer is switched over to an emergency or economy program in the instance of delayed delivery of operating materials and supplies.

The process according to the invention further provides that the data obtained in steps (a) and (b) be used to calculate service and maintenance intervals, and that the respective service and maintenance jobs be requested or ordered via the automatic remote data transmission, preferably an internet connection, using a remote maintenance service. For the computer software concerned in this service and maintenance context, it will be possible to automatically request new versions of evaluation programs or update versions of the operating system.

The new process will also permit the recording of error messages arriving from hardware or software components of the analyzer, automatic error diagnosis, and the requesting or ordering of respective service and maintenance jobs via the automatic remote data transmission.

The invention will also permit initiation of an automatic order according to step (e) in response to a negative result returned by a calibrating or quality control step of the analyzer.

In further development of the invention the proposal is put forward that the data collected automatically by the analyzer in steps (a) to (c) be used to analyze consumer behavior and/or calculate the effective costs for each analysis (total costs of ownership TCOO), and that demand-optimized analyzers or analyzing systems as well as cost-optimized service and maintenance packages be offered on the basis of this information. This function will help calculate the effective costs per test (proportionate equipment costs, service, supplies, work and energy costs), thus permitting the most favorable combination of equipment and maintenance contract to be found for each customer. Moreover, a serviceman can enter the costs of maintenance and service after servicing on site, following which the display on the analyzer will show if or which new maintenance contract will best.

Another object of the invention in the context of improving the information management for analyzing systems and analyzers is achieved by providing the analyzer or analyzing system with a connection for remote data transmission, preferably an internet connection, for automated transmission of data concerning ordering, service and maintenance, and by configuring it as an internet portal for information, i.e., especially product, software, service, maintenance and user information, in the field of medical, environmental or food technology.

On the basis of an analyzer or analyzing system, preferably for applications in medical, environmental or food technology, featuring a device for automatic recording of information on operating materials and supplies, in particular for recording the type and maximum useful life of the operating materials used, as well as types, expiry dates and quantities of supplies used, an analyzer or analyzing system for implementation of the process proposed by the invention includes at least the following elements:

a device for automatically calculating the estimated frequency of analysis from past frequencies of use of the analyzer, or a device for entering the desired frequency of analysis;

a device for calculating the operating materials and/or supplies required per unit of time in dependence of the data on operating materials and supplies and the frequency of analysis;

a connection for remote data transmission, preferably an internet connection, for automated transmission of data concerning product ordering, service and maintenance.

In a variant according to the invention the proposal is put forward that the connection for remote data transmission be provided in a computer-supported central unit of the analyzing system, and that one or several independent single analyzers be provided for determining one sample parameter or parameter group each, and that the single analyzers be coupled to the central unit in a first position, from which position they can be removed in order to be inserted in a second position, preferably a measuring position next to the patient, a so called bedside measuring position. In this way it will be possible to operate several analyzers in a local area network with a central unit, the latter providing the link to the internet.

Advantageously, a bus system may be provided, which will establish in the first position a releasable contact between the single analyzers, and the contact between single analyzers and central unit. The bus system may be provided with a data bus to establish a data link, and/or a fluid bus to exchange washing, calibrating and quality control media, and/or a sample bus to exchange the samples to be tested, and/or an energy supply bus, between the individual components.

Moreover, the analyzer or analyzing system may be furnished with a data link to a laboratory information system (LIS), and a hospital information system (HIS), and/or further laboratory systems without an internet connection of their own.

The required data links may be effected according to the invention by means of wireless technology in the 2.4 GHz range, utilizing the license-free ISM band (industrial, scientific, medical band).

### BRIEF DESCRIPTION OF THE DRAWINGS

The invention will now be explained in more detail, with reference to the schematical drawings attached, wherein

FIG. 1 shows a first variant of an analyzing system according to the invention,

FIG. 2 shows a variant of the invention with a modular analyzing system.

### DETAILED DESCRIPTION OF THE PREFERRED EMBODIMENTS

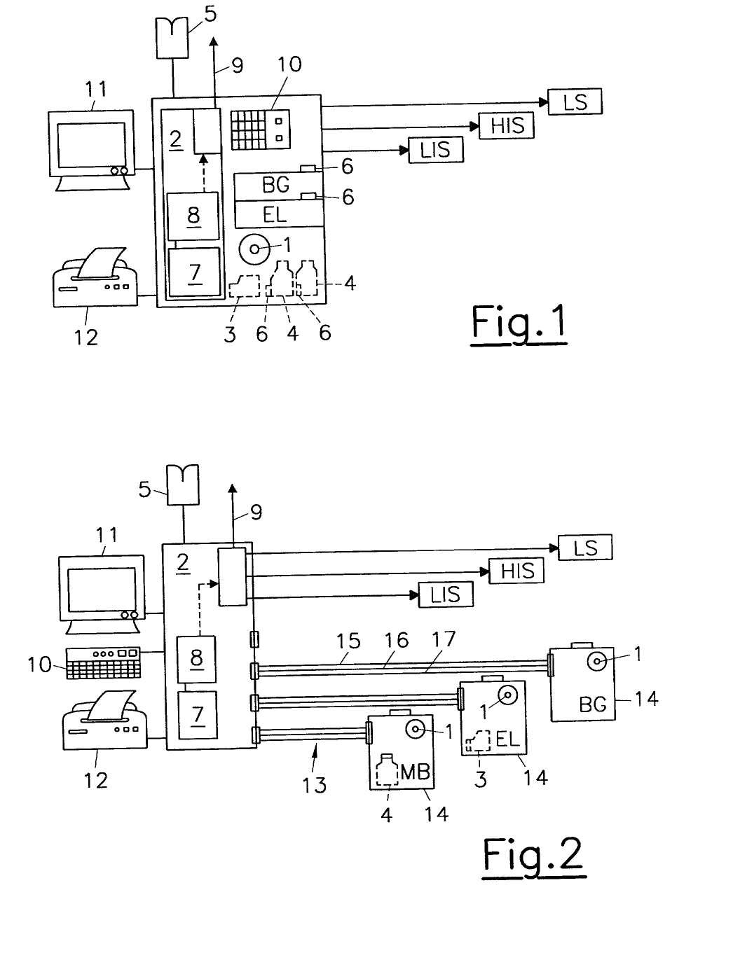

The embodiment which is schematically presented in FIG. 1 as an example for a medical analyzer, is used for analysis of whole blood samples introduced into the analyzer via an input unit 1. In the example shown here the analyzer is provided with a module BG for blood gas analysis (pH, POC₂, PO₂), and a module EL for electrolyte measurement (e.g., Na⁺, K⁺, Cl⁻, Ca⁺⁺). The two modules contain electrochemical or optochemical sensors not shown in this drawing, whose measuring signals are transmitted to a computer unit 2 using suitable control and evaluation programs. The analyzer further contains tanks 3, 4 for washing, calibrating and quality control media, which are controlled by the computer unit 2 and inserted at given time intervals.

By means of a bar code reader 5 and bar codes attached to the operating materials or supply tanks, the characteristic data of operating materials, such as electrochemical and/or optochemical sensors of the analyzer, and the data of supply materials, such as the washing, calibrating and quality control media required for cleaning, calibration and quality control of these sensors, may be recorded. The data may also be recorded via a transponder 6 at the operating materials and supplies.

The computer unit 2 further comprises a unit 7 for calculating the expected frequency of analysis from previous data, and a unit 8 for calculation of the operating materials and supplies required per unit of time. The analyzer is provided with a connection 9 for remote data transmission, preferably an internet connection, for automated transmission of the product ordering, service and maintenance data obtained by unit 8. It would also be possible to enter the desired or expected frequency of analysis via an input unit or keyboard 10. Input and output devices (keyboard 10, monitor 11) may be provided separately, or they may be combined in a touch-screen and directly integrated into the analyzer. The analyzer may further include a printer 12, a data link to a laboratory information system LIS, a hospital information system HIS, and other laboratory systems LS. Above all, connection of systems will be possible that do not have an internet connection of their own.

In the variant shown in FIG. 2 the analyzing system is provided with a computer-supported central unit or a central computer unit 2, and independent single analyzers 14 which are linked to the central unit 2 via a bus system 13. The bus system 13 may comprise a data bus 15, an energy supply bus 17, and a fluid bus 16 for the purpose of exchanging washing, calibrating and quality control media between the individual components. The single analyzers, such as a blood gas analyzer BG, an electrolyte analyzer EL, and an analyzer for diverse metabolites MB, are coupled in a first measuring position (i.e., the position shown in FIG. 2) to the central unit, thus forming a multi-component analyzer. From this position the single analyzers 14 may be transferred to a measuring position remote from the central unit 2 by disconnecting them from the bus system 13.

The transfer of data between the central unit 2 and the single analyzers 14, and the data link to a laboratory information system LIS and hospital information system HIS may also be effected by wireless technology in the 2.4 GHz range, utilizing the ISM band.

What is claimed is:

1. A method for automation of the management of operating materials and/or supplies of an analyzer or analyzing system for use in medical, environmental or food technology, comprising:
(a) automatic recording of data on operating materials and/or supplies, in particular type and maximum useful life of said operating materials used, as well as types, expiry dates and quantities of said required supplies,
(b) entering a desired frequency of analysis, or automatic calculation of an estimated frequency of analysis from past frequencies of use of said analyzer or analyzing system,
(c) automatic calculation of said operating materials and/or supplies required per unit of time, based on data obtained in steps (a) and (b),
(d) determining an optimum point in time for ordering said required operating materials and/or supplies,
(e) automated ordering of said operating materials and/or supplies via a device for remote data transmission.

2. A method according to claim 1, wherein said operating materials and/or supplies are ordered via an internet connection.

3. A method according to claim 1, wherein said unit for remote data transmission is used to provide an internet portal for information on products, software, service, maintenance, and use, in the fields of medical, environmental and food technology.

4. A method according to claim 3, wherein said information on products, software, service, maintenance, and use, is updated each time an automatic order is placed according to step (e).

5. A method according to claim 1, wherein in step (a) said data of at least one operating material of a group consisting of electrochemical and optochemical sensors of said analyzer, and said data of at least one supply material of a group consisting of washing, calibrating and quality control media required for cleaning, calibration and quality control of said sensors is recorded.

6. A method according to claim 1, wherein for calculation of said operating materials and supplies required per unit of time according to step (c) a desired range or desired availability of said analyzer is entered.

7. A method according to claim 1, wherein automatic ordering of operating materials and supplies either is proposed by said analyzer and confirmed by an user or is effected fully automatically by said analyzer after a corresponding function has been activated once.

8. A method according to claim 1, wherein subsequent to said automated ordering of said operating materials and supplies according to step (e) a confirmation of delivery is waited for and, if delivery is delayed, a warning is displayed on said analyzer.

9. A method according to claim 8, wherein in instance of delayed delivery of said operating materials and supplies calibration and quality control cycles of said analyzer are correspondingly extended.

10. A method according to claim 8, wherein in instance of delayed delivery of said operating materials and supplies calibration and quality control cycles of said analyzer are switched over to an emergency or economy program.

11. A method according to claim 1, wherein said data obtained in steps (a) and (b) are used to calculate service and maintenance intervals, and respective service and maintenance jobs are requested or ordered via said automatic remote data transmission.

12. A method according to claim 11, wherein said service and maintenance jobs are requested via an internet connection.

13. A method according to claim 1, wherein error messages arriving from hardware or software components of said analyzer are recorded, and respective service and maintenance jobs are requested or ordered via said automatic remote data transmission.

14. A method according to claim 13, wherein said service and maintenance jobs are requested via an internet connection.

15. A method according to claim 5, wherein an automatic order is initiated according to step (e) in response to a negative result returned by a calibrating or quality control step of said analyzer.

16. A method according to claim 2, wherein an user is offered a help function via said internet connection, as well as access to user groups, a user center, and electronic information media.

17. A method according to claim 2, wherein said internet connection is used for remote repair of hardware or software components of said analyzer.

18. A method according to claim 1, wherein said data collected automatically by said analyzer in steps (a) to (c) are used to analyze consumer behavior and/or calculate effective costs for each analysis, and wherein demand-optimized analyzers or analyzing systems as well as cost-optimized service and maintenance packages are offered on the basis of this information.

19. Analyzer or analyzing system for applications in medical, environmental or food technology, comprising a device for automatic recording of information on operating materials and supplies, in particular for recording type and maximum useful life of said operating materials used, as well as types, expiry dates and quantities of said supplies used, wherein a device is provided for automatically calculating an estimated frequency of analysis from past frequencies of use of said analyzer, or a device for entering a desired frequency of analysis, and wherein said analyzer includes a device for calculating said operating materials and/or supplies required per unit of time in dependence of said data on operating materials and supplies and said frequency of analysis, and wherein said analyzer is further provided with a connection for remote data transmission for purposes of automated transmission of data concerning product ordering, service and maintenance.

20. An analyzing system according to claim 19, wherein said connection for remote data transmission is an internet connection.

21. An analyzing system for determination of medical sample parameters according to claim 19, wherein said connection for remote data transmission is provided in a computer-supported central unit of said analyzing system, and wherein at least one independent single analyzer is provided for determining one sample parameter or one sample parameter group, and wherein said single analyzers are coupled to said central unit in a first position, and are removable from said first position in order to be inserted in a second position, i.e. in a bedside measuring position.

22. An analyzing system according to claim 21, wherein a bus system is provided, for establishing releasable contact between each of said single analyzers, as well as for establishing releasable contact between said single analyzers and said central unit in said first position.

23. An analyzing system according to claim 22, wherein said bus system is provided with a data bus to establish a data link between said single analyzers and said control unit.

24. An analyzing system according to claim 22, wherein said bus system is provided with a fluid bus to exchange washing, calibrating and quality control media between said single analyzers and said control unit.

25. An analyzing system according to claim 22, wherein said bus system is provided with a sample bus to exchange the samples to be tested between said single analyzers and said control unit.

26. An analyzing system according to claim 22, wherein said bus system is provided with an energy supply bus.

27. Analyzer or analyzing system for applications in medical, environmental or food technology, wherein said analyzer or analyzing system is provided with a connection for remote data transmission, for the purpose of automated transmission of data on product ordering, service and maintenance, and is configured as an internet portal for information, especially information on products, software, service, maintenance, and use, in the fields of medical, environmental or food technology.

28. An analyzing system according to claim 19, wherein said analyzer or analyzing system is provided with a data link to a laboratory information system LIS, a hospital information system HIS and further laboratory systems.

29. An analyzing system according to claim 27, wherein said analyzer or analyzing system is provided with a data link to a laboratory information system LIS, a hospital information system HIS and further laboratory systems.

30. An analyzing system according to claim 29, wherein said data transfer is effected by means of wireless technology in the 2.4 GHz range, utilizing a license-free ISM band.
